(19) United States
(12) Patent Application Publication
(10) Pub. No.: US 2005/0256903 A1
(43) Pub. Date: Nov. 17, 2005

(54) Managing a home network

(76) Inventors: Bartel Marinus Van De Sluis, Eindhoven (NL); Elmo Marcus Attila Diederiks, Eindhoven (NL); Koen Hendrik Johan Vrielink, Eindhoven (NL); David Peter Louis Simons, Eindhoven (NL); Adrian Martel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/518,269

(22) PCT Filed: Jun. 12, 2003
(86) PCT No.: PCT/IB03/02627

§ 371 Date: Dec. 16, 2004

(30) Foreign Application Priority Data
Jun. 24, 2002 (EP) 02077503.7

(51) Int. Cl. G06F 17/00

(52) U.S. Cl. 707/104.1

(57) ABSTRACT

This invention relates to a method of managing a media system (103, 201, 208) with a group identifier in a network (210) of media systems. The invention further relates to a media system for managing a network of media systems with a group identifier. The media system can be may be a set-top box, a TV, a PC, a DVD player, a radio, a screen, a camera or a VCR. Said method includes the steps of determining a status of the network, wherein the status represents the group identifier, presence and/or absence of at least one media system; and determining the group identifier for at least one media system based on the determined status. Said step of determining the group identifier comprises the alternative four steps of resetting the group identifier, when said media system is disconnected from the network; or giving an existing group identifier to a first media system (201), when said media system without a group identifier is connected to a second media system (202) having said existing group identifier; or keeping separate group identifiers to a third (203) and a fourth media system (204), when the third and the fourth media system are connected to the network; or giving a first group identifier specified by a user, when a fifth media system (205) is connected to the network to one or more media systems where none of these has a group identifier, and assigning the first group identifier to all of said media systems. Said method further includes the step of: giving a second group identifier specified by a user to a sixth media system (206). Hereby, it is made easy for a user to add, move and remove media systems without the user interaction, since the media systems themselves determine the group identifiers.

This invention relates to a method of managing a media system with a group identifier in a network of media systems.

The present invention also relates to a computer system for performing the method.

The present invention further relates to a computer program product for performing the method.

This invention further relates to a media system for managing a network of media systems with a group identifier.

The international application WO 00/43900 discloses a method of adding a device to a network. The device can communicate using various protocols, such as Lon Works, CE-Bus, X-10, over an AC power line. A new device can be linked or connected to already existing devices by means of a physical device, an installer.

It is known to have an in-home network enabling users to do various activities on various devices (PC's, TVs, etc), such as surfing the web, watching a TV program or having a videoconference from all over the house. Furthermore, such a network enables users to easily move these activities and corresponding devices from room to room. To be able to support this type of activities, the system needs to know approximately where the various devices are located.

It is known to achieve this by storing a group identifier, e.g. a room name, in each device. However, the problem is that it might be time-consuming, difficult and cumbersome for a user to ‘fill in’ this group identifier for each device each time the device is moved from one room to another.

However, the prior art forces the user to be involved in the process of adding a device to a network by means of the use of an additional device, namely said installer.

It is therefore an object of the present invention to make it easy for a user to add, move and remove media systems without user interaction and without the use of additional devices and at the same time ensuring that said media systems still know to which group in which room they are connected.

The above and other problems are solved by said method wherein the method comprises the steps of:
determining a status of the network, wherein the status represents the group identifier, presence and/or absence of at least one media system; and
determining the group identifier for at least one media system based on the determined status.

It is hereby made easy for the user to add, move or remove media systems without user interaction since the first step determines the status of the network. The status may represent the group identifier(s), presence and/or absence of one or more media system(s) in the network. It may thereby be known how media systems are related to one another. In this step, the media system(s) is/are able to detect changes, such as connection or disconnection and or movement of neighbours on the network.

In the second step, said status may then determine the group identifier(s) for one or more media systems. In the second step, different alternative situations are taken care of. Firstly, the group identifier may be reset when a media system is disconnected from the network. Alternatively and secondly, an existing group identifier may be given to a media system; this may happen, when said media system, which as a starting point does not have a group identifier, is connected to another media system already having an existing group identifier. Alternatively and thirdly, when two media systems are connected to each other where both already have a group identifier, these latter are left unchanged. Alternatively and finally, another group identifier may be given to another media system, and then assigned to all other media systems previously not having a group identifier.

It is hereby an advantage of the invention that an easier and simpler configuration of an in-home network is achieved without user interaction.

It is further an advantage of the invention that it is made easy for the user to add, move and remove media systems without user interaction, such as a determination (by the user) of a group identifier and a subsequent inclusion of that, since the media systems themselves determine the group identifiers.

In this way ‘first time installation’ and ‘change of the configuration’ of an in-home network are simplified since the required user interaction for doing so is kept to a minimum.

In a preferred embodiment of the invention, the step of determining the group identifier comprises the step of:
resetting the group identifier, when said media system is disconnected from the network; or
giving an existing group identifier to a first media system, when said media system without a group identifier is connected to a second media system having said existing group identifier; or
keeping separate group identifiers to a third and a fourth media system, when the third and the fourth media system are connected to the network; or
giving a first group identifier specified by a user, when a fifth media system is connected to the network, to one or more media systems where none of these has a group identifier, and assigning the first group identifier to all of said media systems.

In the first step, the group identifier may be reset when a media system is disconnected from the network.

In the second step, a group identifier already existing may be given to a media system not having a group identifier, when that media system is connected to another media system with said existing group identifier.

In the third step, when two media systems already having a group identifier are being connected to each other, these identifiers are left unchanged.

In the fourth step, a group identifier may be given to a media system, and subsequently be assigned to other media systems not having a group identifier.

In these four alternative steps the media systems themselves determine the group identifiers.

In a preferred embodiment of the invention, said method further comprises the step of
giving a second group identifier specified by a user to a sixth media system.

The user may hereby specify said group identifier himself, the user is here directly involved in the definition and the specification of the group identifier. The user may hereby control which other media systems access or communicate with said sixth media system.

The object of the invention is further solved by a media system for managing a network of media systems with a group identifier comprising:
means for determining a status of the network, wherein the status represents the group identifier, presence and/or absence of at least one media system; and
means for determining the group identifier for at least one media system based on the determined status.

In a preferred embodiment of the invention, the means for determining the group identifier comprises:
means for resetting the group identifier, when said media system is disconnected from the network;
means for giving an existing group identifier to a first media system, when said media system without a group identifier is connected to a second media system having said existing group identifier;
means for keeping separate group identifiers to a third and a fourth media system, when the third and the fourth media system are connected to the network; and
means for giving a first group identifier specified by a user, when a fifth media system is connected to the network, to one or more media systems where none of these has a group identifier, and assigning the first group identifier to all of said media systems.

In a preferred embodiment of the invention, the media system further comprises:
means for giving a second group identifier specified by a user to a sixth media system.

In a preferred embodiment of the invention, the media system may be a set-top box, a TV, a PC, a DVD player, a radio, a screen, a camera or a VCR.

The media system provides the same advantages for the same reasons as described previously in relation to the method.

The invention will be explained more fully below in connection with preferred embodiments and with reference to the drawings, in which:

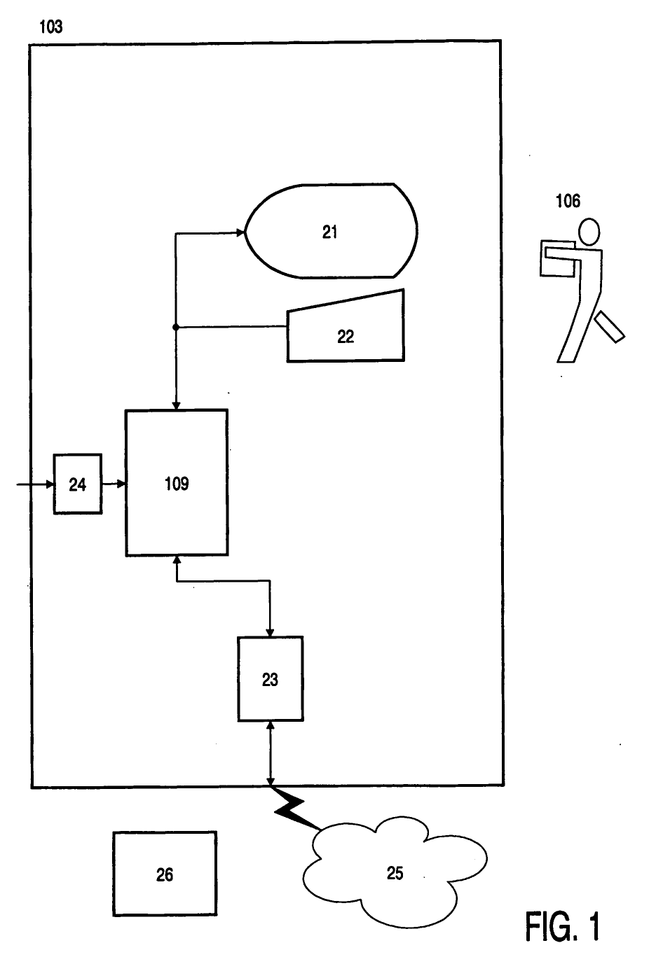

FIG. 1 shows a media system and a computer program product;

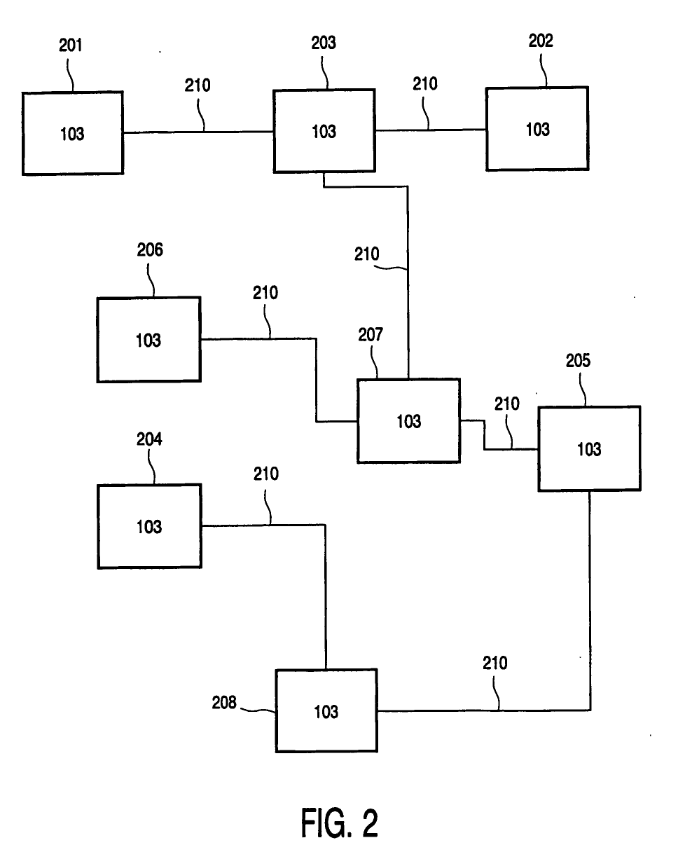

FIG. 2 shows a network of media systems; and

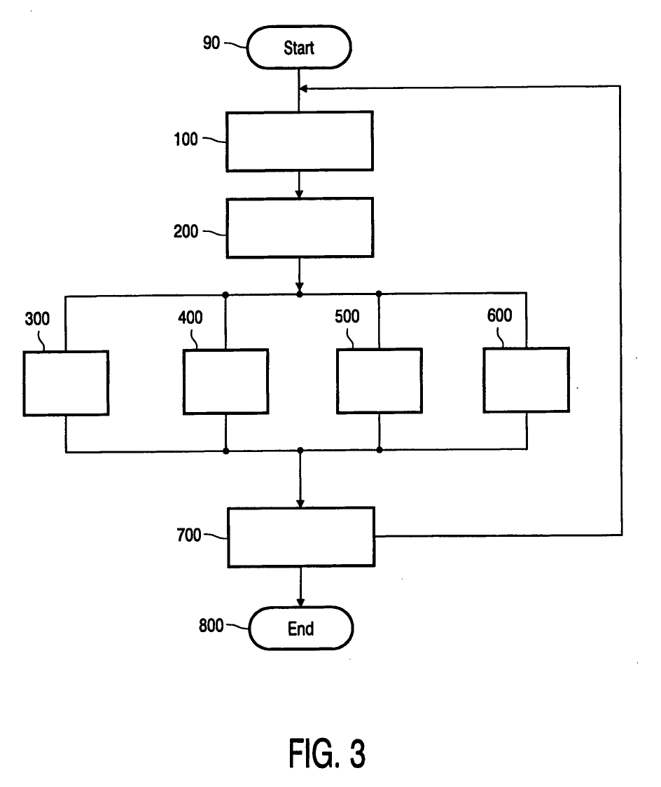

FIG. 3 shows a method of managing the media system with a group identifier in the network of media systems.

Throughout the drawings, the same reference numerals indicate similar or corresponding features, functions, etc.

FIG. 1 shows a media system and a computer program product. The media system in a preferred embodiment of the invention is shown by reference numeral 103. A user as indicated by reference numeral 106 may operate the media system and have various information, such as a media content, presented on the media system. The media content may be a live content, like a TV program, a video available to be seen on demand, an interactive live broadcasted TV on the Internet, Internet TV, Internet sites only available when, e.g. a certain event is happening, a movie, radio broadcastings or any other media content that may be watched during the broadcast, or said media content may be recorded (e.g. a photo), i.e. stored on the media system, for a later presentation, i.e. a later playback. During the operation of the media system the user may have information presented as indicated by reference numeral 21 on a display. The user may respond to an instruction given by the display by means of an input device as shown by reference numeral 22. The response may for example be giving or altering a group identifier representing how said media system is grouped to other media systems. The input device may be a keyboard, fields sensitive to touch, a mouse, etc. The media system of reference numeral 103 may further have the processor, as also previously indicated by reference numeral 109. The processor is arranged to receive inputs from the input device and by means of a connection, e.g. the net connection as indicated in reference numeral 23. The net connection may be used to transmit information from the media system—to a server and vice versa. The net connection may further be used to exchange information with other media systems, e.g. said group identifier. The processor may then present various information by means of the display. The processor is further arranged to receive inputs from reference numeral 24, a device designed to receive various kinds of media content from various sources. The device, reference numeral 24, may be connected to a connection point such as an antenna inlet for TV, radio or a satellite receiver, a SCART to a TV or to a VCR, etc. The media content—when the media system is a personal computer, a lap-top, etc—may also be received from 25, the Internet connection, e.g. via a modem, ADSL, x-DSL or the like.

Generally, when the processor is arranged to receive inputs from said devices of and by means of the net connection, it may further be used to perform steps of a method described in FIG. 3, where the media system is involved.

The computer program product is shown by means of reference numeral 26. The computer program product may be designed to perform the steps of the method that will be described in FIG. 3.

FIG. 2 shows a network of media systems in a preferred embodiment of the invention. Reference numeral 210 is the network connecting the various media systems, all shown by reference numerals 103. The network may be laid out in various topologies other than those shown. The network topology may be a star, a line, a bus, a token ring and combinations thereof, with redundant connection, etc. The network may use any kind of electrical connector connection in order to connect and/or disconnect said media system to/from the network. To said network, media content—when the media system is a personal computer, a lap-top, etc,—may be received from an Internet connection, e.g. via a modem, ADSL, x-DSL or the like connection or even be generated by the media system by it self, e.g. a photo from a camera.

The media system may be powered by means of the network or by means of external power sources such as 110 V AC, 240 V AC power, battery power, etc. Reference numerals 201 through 208 designate various media systems, which may be of the same or different kind. As an example of media systems, a set-top box may be connected to a TV sharing the network. As another example of media systems, a PC and a radio both with access to the Internet may share the network. By means of a group identifier the various media systems may know or may request knowledge of which other media systems that are currently attached or connected to the network. Said network may be used as a stand-alone network in one room and/or it may be laid out to connect to more areas with sub-networks (in various network topologies) such as more rooms in a house, in a factory or even in a company as well. The number of media system may vary; only a limited number of media systems and combined network topologies are shown for illustrative purposes.

FIG. 3 shows a method of managing the media system with a group identifier in the network of media systems.

In step 90, the method in accordance with a preferred embodiment of the invention is started. Variables, flags, buffers, etc., keeping track of group identifiers corresponding to the status of media systems in the network, etc, on said media system are set to default values. When the method is started a second time, only corrupted variables, flags, buffers, types, etc, are reset to default values.

In step 100, a status of the network may be determined. The status may represent the group identifier, presence and/or absence of at least one media system. With said information retrieved from the network by the media systems communicating on and with the network, a complete status may be established. Hereby, it may be known which media systems(s) is/are present and/or absent, and further by use of their corresponding group identifiers, it may be known how media systems are related to one another. In other words, the media systems are able to detect changes (e.g. connection or disconnection, i.e. attachment(s), a moving or a removal of neighbours on the network. This is possible since knowledge of network topology is known to the media systems and thereby also knowledge of their most proximate neighbours.

In step 200, the group identifier may be determined for at least one media system based on the determined status. The information representing the status—as discussed in the foregoing step—including was group identifier, presence and/or absence of at least one media system. This may be terms that rather relate to the physical location, such as connected and/or disconnected neighbouring media systems on the network. Step 200 constitutes a generalisation of steps 300, 400, 500 and 600. In other words, on the basis of step 200, one of the steps 300 through 600 is selected as the proper alternative. When these steps are being performed in the method, they may currently automatically reflect and keep track of the group identifiers, presence and/or absence of one or more media systems.

In step 300, the group identifier may be reset. The group identifier may be reset when a media system is disconnected from the network. The reset status of the group identifier should indicate that said media system in the first place is disconnected, and—as a consequence—that it does not belong to any group or grouping of media systems. It may be the case, as an example, that a media system is being disconnected from any other media system and thereby from the network as such; its group identifier is therefore reset, hence it does not belong to any group of media system on the network any more. This also has the intended effect that other media systems previously accessing or communication with said particular—now—disconnected media system—cannot do so any more.

In step 400, an existing group identifier may be given to a first media system. It may be the case, when said media system, which as a starting point does not have a group identifier, is connected to a second media system, the first media system may then be given said existing group identifier that already identified the second media system. As a consequence—both media systems, i.e. said first and second media systems, may now have the same, common group identifier, i.e. the originally existing group identifier of the second media system. It may even be the case, that the above-mentioned step is repeated for more media systems not having a group identifier, i.e. when a media system or a group of media systems without a group identifier become(s) connected to a media system that already has a group identifier, all media system will be connected with and/or to that group identifier.

Now all of said media systems—discussed in this step—belong to the same group of media systems on the network. This has the intended effect that these media systems may access or communicate with one another within said group identified by said existing group identifier.

In step 500, separate group identifiers may be kept to a third and a fourth media system. The separate group identifiers may be kept to said media systems when these are connected to each other and then to the network. In the case that said two media systems—each already having a group identifier—are being connected to each other and to the network, their separate and individual group identifiers remain unchanged. In other words, when two media systems are being connected to each other where both (media systems) already have a group identifier, their separate group identifiers remain the same.

Still the third and fourth media systems—discussed in this step—do not belong to the same group of media systems on the network, since their separate and individual group identifiers are not changed or—in other words—they are still kept different. This has the maintained and intended effect that these media systems may access or communicate with other media system with the same access (referred to by means of the group identifiers valid after the connection to the network) from these as before the connection to the network.

In step 600, a first group identifier may be given to a fifth media system, and then assigned to all other media systems previously not having a group identifier. The first group identifier may be specified by a user in the case that the fifth media system is connected to the network of one or more (other) media systems and where none of these has a group identifier. Thereafter the first group identifier may be assigned to all of said media systems (previously not having a group identifier), including the fifth media system itself. In other words, when a media system is being connected to one or more media systems, all of these not having any group identifier, it is assumed that they together will combine to a group, one media system may then ask the user to specify the group identifier (e.g. room name) that will be assigned to all those media systems.

Now all said media systems, each having said first group identifier, belong to the same group of media systems on the network. This has the intended effect that these media systems may access or communicate with one another within the said group identified by said first group identifier.

In step 700, a second group identifier may be given. The second group identifier may be specified by a user and then be given to a sixth media system. Here—as opposed to the foregoing steps—the user is directly involved in the definition and the specification of a group identifier, i.e. in the said specified second group identifier. The user of the network may have—for a particular media system—specific requirements for the later identification of it, and therefore, he may—as opposed to all the foregoing steps—desire to be directly involved in its group identifier definition. As a consequence of a particular media system with a corresponding particular group identifier, namely the second group identifier, the user may thereby control which other media systems access or communicate with it, since its group identifier, i.e. the second group identifier, was not automatically given by a media system, but by him.

In other words, the user may in this step explicitly set a group identifier for any media system.

Usually, the method will start all over again as long as the media system is powered. Otherwise, the method may terminate in step 800; however, when the media system is powered again, etc, the method may proceed from step 100.

Said media system may be a set-top box, a TV, a PC, a DVD player, a radio, a screen, camera or a VCR capable of receiving, handling and exchanging group identifiers on said network.

Based on the above alternative steps, first time installation of a complete in-home network and the allocation of media system to groups (rooms) may be simplified. The user may only need to follow these 3 steps:

Step 1: Connect media systems within each room to each other (group).

Step 2: Give each room (group) a name (by using a media system from the group concerned), by means of an input device, such as a touch-screen, a keyboard or a remote control.

Step 3: Interconnect the groups of media systems.

Said steps may also make it easy to change the configuration of the home network. For instance, if a new media system (such as a screen, or camera) is added, this media system may assume that it is in the same room as the media system(s) it is being connected to. In most cases, this will be the correct assumption. Any media system may support an easy way to overrule a wrong assumption by any media system. For instance, the user interface of any media system—capable of doing so—may have a map of media systems that enables a user to see which media system(s) is/are allocated to which room, and to change this allocation on the system map accordingly.

The user must be able to set or reset a group identifier (e.g. a room name) for any media system in the network. In order to do so, the user needs a device that allows user interaction and textual information to be entered. Since not all media systems support this, it might be necessary to define steps of interaction that enable interactive media systems to be used to enter group names for media systems belonging to another group.

An alternative solution for assigning media systems to groups is to use a piece of hardware (such as a hub) as a ‘group separator device’ in order to indicate the beginning and ending of a group in the network. A disadvantage of this approach is that it requires additional hardware with ensuing additional costs. This is avoided by the approach proposed by the invention.

A computer readable medium may be magnetic tape, optical disc, digital video disk (DVD), compact disc (CD record-able or CD write-able), mini-disc, hard disk, floppy disk, smart card, PCMCIA card, etc.

1. A method of managing a media system with a group identifier in a network of media systems, the method comprising the steps of:
determining a status of the network, wherein the status represents the group identifier, presence and/or absence of at least one media system; and
determining the group identifier for at least one media system based on the determined status.

2. A method according to claim 1, characterized in that the method further comprises the step of:
giving a second group identifier specified by a user to a sixth media system.

3. A method according to claim 1, characterized in that the step of determining the group identifier comprises the step of:
resetting the group identifier, when said media system is disconnected from the network; or
giving an existing group identifier to a first media system, when said media system without a group identifier is connected to a second media system having said existing group identifier; or
keeping separate group identifiers to a third and a fourth media system, when the third and the fourth media system are connected to the network; or
giving a first group identifier specified by a user, when a fifth media system is connected to the network, to one or more media systems where none of these has a group identifier, and assigning the first group identifier to all of said media systems.

4. A method according to claim 1, characterized in that the media system is a set-top box, a TV, a PC, a DVD player, a radio, a screen, a camera or a VCR.

5. A computer system for performing the method according to claim 1.

6. A computer program product comprising program code means stored on a computer readable medium for performing the method of claim 1 when the computer program is run on a computer.

7. A media system for managing a network of media systems with a group identifier, said media system comprising:
means for determining a status of the network, wherein the status represents the group identifier, presence and/or absence of at least one media system; and
means for determining the group identifier for at least one media system based on the determined status.

8. A media system according to claim 7, characterized in that means for determining the group identifier comprises:
means for resetting the group identifier, when said media system is disconnected from the network;
means for giving an existing group identifier to a first media system, when said media system without a group identifier is connected to a second media system having said existing group identifier;
means for keeping separate group identifiers to a third and a fourth media system, when the third and the fourth media system are connected to the network; and
means for giving a first group identifier specified by a user, when a fifth media system is connected to the network, to one or more media systems where none of these has a group identifier, and assigning the first group identifier to all of said media systems.

9. A media system according to claim 7 characterized in that the media system further comprises:
means for giving a second group identifier specified by a user to a sixth media system.
